(19) United States
(12) Patent Application Publication
(10) Pub. No.: US 2023/0264594 A1
(43) Pub. Date: Aug. 24, 2023

(54) SINGLE PHASE VEHICLE TO HOME ELECTRIC VEHICLE SUPPLY EQUIPMENT

(71) Applicant: Auto Motive Power Inc., Santa Fe Springs, CA (US)

(72) Inventors: Troy NERGAARD, Mercer Island, WA (US); Anil PARYANI, Cerritos, CA (US); Jiaqi LIANG, La Crescenta, CA (US); Moritz BOECKER, Millbrae, CA (US)

(21) Appl. No.: 18/113,463

(22) Filed: Feb. 23, 2023

Related U.S. Application Data
(60) Provisional application No. 63/313,176, filed on Feb. 23, 2022.

(51) Int. Cl. B60L 55/00; B60L 53/66; B60L 53/53; B60L 53/18; H02J 3/32

(52) U.S. Cl. CPC B60L 55/00; B60L 53/66; B60L 53/53; B60L 53/18; H02J 3/322

(57) ABSTRACT

An EVSE with additional switches and control to allow for 120V/240V split-phase homes to be powered by an electric vehicle with only two AC power pins in its charge port.

### FIELD

This relates to an electric vehicle powering a home through an Electric Vehicle Supply Equipment during a grid outage.

### BACKGROUND

Electric vehicles (EVs) and plug-in hybrid vehicles have battery energy storage and power electronics that convert the alternating current (AC) power to direct current (DC) power to charge the battery. The same electronics can be configured to also allow power to flow from DC to AC and support loads off the vehicle. In North America and many other countries, the standard vehicle connector (SAE J1772) only has two power pins for AC (Line 1 (L1), and either Line 2 (L2) or Neutral (N)), and optionally two power pins for DC. Without three pins for AC (L1, L2, N), it is challenging to support Vehicle to Home (V2H) applications where an EV battery or off-board energy storage system (ESS) can power the home.

Electric Vehicle Supply Equipment (EVSE) is a device off board the vehicle that interfaces the utility grid or AC source with the vehicle. An EVSE communicates with the vehicle and enables power to flow between the source and the load if appropriate. EVSEs can be designed to allow power to flow from the vehicle to the AC source or external loads.

Residential homes sometimes have back-up generators that are used to power up part of or all of a home when the utility grid goes down. Those back-up generators are often loud and powered by fossil fuels. Back-up generators are often paired with transfer switches that disconnect the home from the utility grid and connect it to the generator.

A typical North American single-family home consists of split phase 120V/240V utility service, consisting of Line 1, Line 2, and Neutral. The 120V household loads are usually distributed between the two 120V phases.

### BRIEF DESCRIPTION OF THE DRAWINGS

FIG. 1 illustrates an exemplary EVSE with nontraditional contactors C3 and C4 that can be configured to provide 120V power from a vehicle to a house, according to an embodiment of the disclosure.

FIG. 2 illustrates the exemplary EVSE with nontraditional contactors C3 and C4 in positions to facilitate charging of the vehicle using power from the house, according to an embodiment of the disclosure.

FIG. 3 is a block diagram illustrating the exemplary steps in using the EVSE of FIG. 1 to provide power from a vehicle to a house, according to an embodiment of the disclosure.

FIG. 4 is a block diagram illustrating an example EVSE auxiliary power supply with an integrated battery for black start, according to an embodiment of the disclosure.

FIG. 5 is an alternative scheme for EVSE auxiliary power supply, which draws power from the control pilot line with black start capability, according to an embodiment of the disclosure.

FIG. 6 is an Alternative Configuration using the Coupler's DC pin as a Neutral connection.

### DETAILED DESCRIPTION

Various aspects of the novel systems, apparatuses, and methods are described more fully hereinafter with reference to the accompanying drawings. Aspects of this disclosure may, however, be embodied in many different forms and should not be construed as limited to any specific structure or function presented throughout this disclosure. Rather, these aspects are provided so that this disclosure will be thorough and complete and will fully convey the scope of the disclosure to those skilled in the art.

Based on the teachings herein, one skilled in the art should appreciate that the scope of the disclosure is intended to cover any aspect of the novel systems, apparatuses, and methods disclosed herein, whether implemented independently of or combined with any other aspect. For example, an apparatus may be implemented, or a method may be practiced using any number of the aspects set forth herein. In addition, the scope is intended to encompass such an apparatus or method which is practiced using other structure, functionality, or structure and functionality in addition to or other than the various aspects set forth herein. It should be understood that any aspect disclosed herein may be embodied by one or more elements of a claim.

As EVs become more prolific, it would be great to use that EV in the garage to provide back-up power to critical household loads when utility power is unavailable. However, given a typical North American house with split-phase 240V/120V (sometimes referred to as 220V/110V) three wire (L1, L2, N) power and a typical North American EV with only two AC power pins, the two sides don't exactly match up when trying to power the house from the EV.

In one embodiment, two additional switches, some additional wires, and some additional control software can be added to the EVSE to allow the 120V generated by the vehicle to provide power to critical loads. Furthermore, those critical loads could be on either of the house's 120V phases and a subpanel is not required. In this scenario, 240V loads would not be powered and their circuit breakers could be switched off. Typical 240V household loads include ranges, dryers, and HVAC systems. Loads such as dryers and ranges are not critical during a power outage and electrical HVAC systems often require significant power and, therefore, might be beyond the capabilities of the vehicle charger and would deplete a typical EV battery's energy rather quickly.

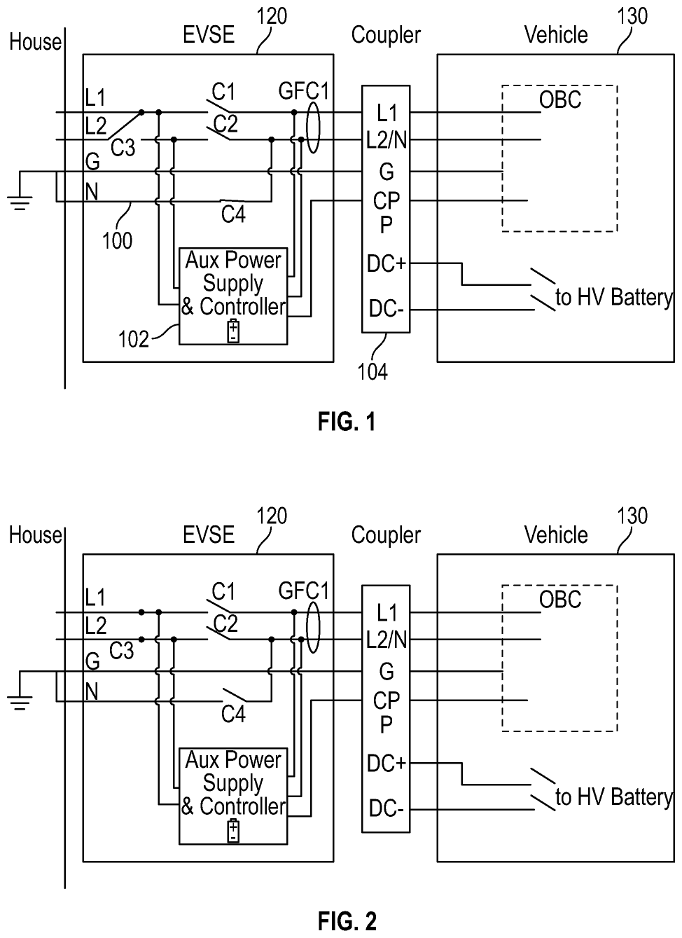

An example of the additional switches and wires needed are shown in FIG. 1. The contactor C3 is added on the house side of the EVSE 120 to reconfigure wires L1 and L2 so they can be electrically connected at the house when in V2H mode. The wire 100 and contactor C4 are added to connect the vehicle side wire L2 to Neutral at the house in V2H mode. When the utility grid power is available and the EV 130 wants to be charged, C3 is in a position to allow L2 to be connected to C2 and C4 is in an open position, as shown in FIG. 2. In order to control the additional switches and allow for power-up when the utility grid is down, some additional auxiliary power wires are needed as well as a small energy source such as a battery (collectively shown as the Aux Power Supply & Controller 102 in FIG. 1).

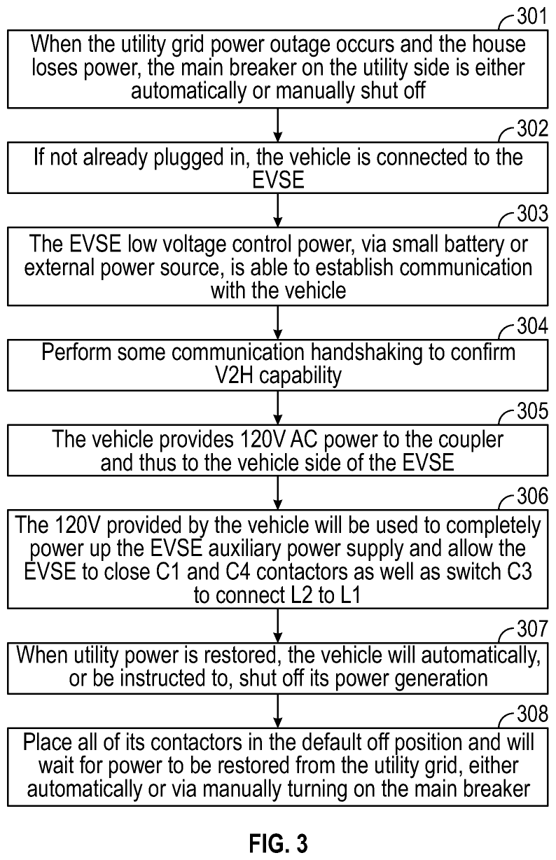

The sequence of events to allow V2H power are described here and as illustrated in the flow chart of FIG. 3. According to one embodiment, once the utility grid power outage occurs and the house loses power, the main breaker on the utility side is either automatically or manually shut off (step 301). If not already plugged in, the vehicle is connected to the EVSE such as the one shown in FIGS. 1 and 2 (step 302). The EVSE low voltage control power, via small battery or external power source, is able to establish communication with the vehicle (step 303). After some communication handshaking to confirm V2H capability (step 304), the vehicle provides 120V AC power to the Coupler (104 in FIG. 1) and thus to the vehicle side of the EVSE (step 305). At this point, C1, C2, and C4 of the EVSE are open. The 120V provided by the vehicle will be used to completely power up the EVSE auxiliary power supply and allow the EVSE to close C1 and C4 contactors as well as switch C3 to connect L2 to L1 (step 306). At this point the vehicle can power up 120V critical loads throughout the house, regardless of what electrical phase they are wired to.

When utility power is restored, the vehicle will automatically, or be instructed to, shut off its power generation (step 307). The EVSE will then place all of its contactors in the default off position and will wait for power to be restored from the utility grid, either automatically or via manually turning on the main breaker (step 308). At this point the EVSE can charge the vehicle if needed.

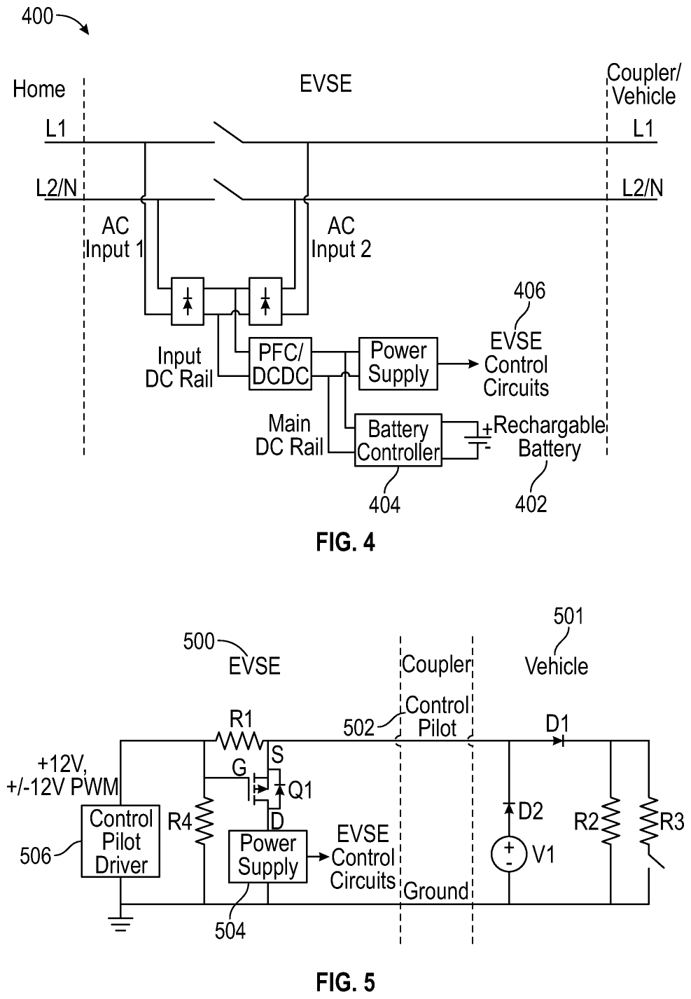

An example of the EVSE auxiliary power supply (e.g., the Aux Power Supply & Controller 102 of FIG. 1) for black start is shown in FIG. 4. The EVSE power supply circuit contains an integrated energy storage, such as a rechargeable lithium-ion battery 402, and an optional AC input 2 that connects to the vehicle side L1 and L2/N lines. Using a lithium-ion battery 402 allows space and weight saving, compared to other energy storage option such as lead-acid battery. When the utility grid is down, power from AC input 1 is lost. Though the battery controller 404, the internal battery 402 can power up the EVSE control circuits 406. Once the vehicle initiates V2H mode and outputs 120V, AC input 2 can supply additional power to the EVSE 400 for configurating its internal switches and recharge the battery.

Another example of EVSE auxiliary power supply for black start is shown in FIG. 5. The EVSE 500 draws auxiliary power from the vehicle 501 through the Control Pilot line 502. A traditional EVSE Control Pilot line is powered only by the EVSE side driver circuit, which outputs +12V and +/−12V PWM, through a resistor (R1, typically 1 k Ohm). The Vehicle side consists of only passive loads (D1, R2, R3) and sensing circuits. In this new design, the Control Pilot line 502 is also powered by the Vehicle side supply V1, which has a voltage level typically lower than 6 V, through a blocking diode D2. The EVSE side auxiliary power supply 504 connects to the Control Pilot line 502 through a MOSFET Q1, such as a P-channel MOSFET. When the Control Pilot driver circuit 506 outputs +12V, MOSFET Q1 disconnects the EVSE power supply (typically has much lower input impedance than R1) from the Control Pilot line 502, and hence allows the 12V signal duty cycle information to pass through to the Vehicle sensing circuit. When the Control Pilot driver circuit 506 outputs −12V, MOSFET Q1 is turned on and connects the EVSE power supply 504 to the Control Pilot line 502, and the Control Pilot line 502 is clamped and powered by the Vehicle side supply V1. During black start, the EVSE Control Pilot driver 506 is down (typically output shorts to ground or high impedance). Once the EVSE 500 is connected to the Vehicle 502, the Control Pilot line 502 is powered by the Vehicle supply V1, and resistor R4 turns on MOSFET Q1 which delivers power to the EVSE power supply.

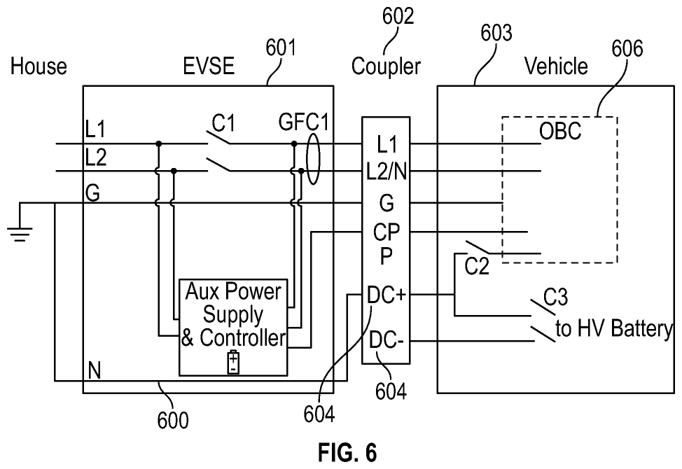

In another embodiment, there is an alternative method that also allows a vehicle using the standard single-phase charge coupler to supply power to a split-phase 120V/240V house. This alternative method, shown in FIG. 6, requires that the charge coupler 602 have DC pins 604 on it and assumes that those DC pins 604 are not used for their original purpose during V2H operation. The addition of a neutral wire 600 in the EVSE that is connected to the DC+ (or DC−) pin in the Coupler will allow for the house neutral to be connected to the vehicle. This alternative method requires an additional contactor C2 to be added to the vehicle 603. It also requires that the vehicle's on-board charger (OBC) 606 be capable of generating a neutral that is centered between L1 and L2. In this alternative method, the vehicle 603 can supply both 240V and 120V house loads with power. The transition process is similar to what is described in FIG. 5, except the vehicle will need to close switch C2 and make sure switch C3 is open before providing power to the EVSE 601.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to e-mobility systems, including automotive, some of which are illustrated by way of example in the figures and in the following description of the preferred aspects. The detailed description and drawings are merely illustrative of the disclosure rather than limiting, the scope of the disclosure being defined by the appended claims and equivalents thereof.

What is claimed is:

1. A Electric Vehicle Supply Equipment (EVSE) connecting a vehicle to a house via a first input line and a second input line, the first input line comprising a first contactor, the second input line comprising a second contactor, the EVSE comprising:
an auxiliary power supply;
a third input line connecting the second input line on the vehicle side of the EVSE to neutral at the house,
a third contactor configured to connect the first and second input lines at a house side of the EVSE, to support split, phase power and provide loads from the vehicle to the house;
wherein the third line comprises a fourth contactor;
wherein one or more of the first, second, third, and fourth contactors can be operated to provide bi-directional charging between the vehicle and housing; and
wherein a charge coupler on the EVSE includes only two AC power pins for connecting to a charge port of the vehicle.

2. The EVSE of claim 1, wherein when the house is powered by utility grid, vehicle is charged by setting the third contactor in a first position to allow the second input line to be connected to the second contactor and setting the fourth contactor in an open position.

3. The EVSE of claim 1, wherein the EVSE is configured to communicate with the vehicle when grid power is unavailable for the house, wherein power for the communication is derived from an onboard energy source or from the auxiliary power supply.

4. The EVSE of claim 3 wherein the auxiliary power supply comprises a rechargeable lithium-ion battery and an optional AC input that connects to the first and second input lines on the vehicle.

5. The EVSE of claim 3, wherein the auxiliary power supply comprises a control pilot line configured to allow the EVSE to draw power from the vehicle, wherein the control pilot line is powered by a vehicle side supply through a blocking diode.

6. The EVSE of claim 5, wherein the auxiliary power supply on the EVSE connects to the control pilot line through a MOSFET.

7. The EVSE of claim 1, wherein the EVSE is configured to close the first contactor and the fourth contactor and set the third contactor in a second position to allow the second contactor to be connected to the first contactor to power the house using a power source in the vehicle when grid power is unavailable.

8. The EVSE of claim 1, wherein the EVSE is configured to communicate with a transfer switch or smart panel when grid power is unavailable to the house.

9. The EVSE of claim 1 wherein the charge coupler comprises 2 DC power pins; and
wherein the EVSE is configured to utilizes one of the 2 DC power pins of the charge coupler to provide neutral to a split phase power application.

10. The EVSE of claim 1 wherein the auxiliary power supply comprises a battery; control circuits; a battery controller configured to power up the control circuits through the battery controller.

11. The EVSE of claim 10 wherein an AC input connecting the auxiliary power supply to the first input line can supply power from the battery to configure the contactors of the EVSE when the utility grid is unavailable to the house.
